(19) United States
(12) Patent Application Publication
(10) Pub. No.: US 2014/0062714 A1
(43) Pub. Date: Mar. 6, 2014

(54) FLASHING DOORBELL SECURITY LAMP

(71) Applicants: Robert W. Chvatal, Downers Grove, IL (US); John V. Chvatal, Indian Head Park, IL (US)

(72) Inventors: Robert W. Chvatal, Downers Grove, IL (US); John V. Chvatal, Indian Head Park, IL (US)

(21) Appl. No.: 13/604,297

(22) Filed: Sep. 5, 2012

(51) Int. Cl. G08B 5/36

(52) U.S. Cl. 340/815.73; 340/815.4

(57) ABSTRACT

Methods and systems for indicating the presence of a security system on a building are described. Existing security systems do not adequately provide notice to others that a property is protected by a security system. The methods and systems described herein solve this problem by providing a flashing lamp doorbell that may provide notice that a property is protected by a security system, and may optionally convey status information about the current state of the property.

### BACKGROUND

Security systems have become an increasingly important means by which institutions, corporations, and individuals protect their families and possessions. Security systems have grown over the years from independent and isolated security measures into interconnected systems that monitor dozens of characteristics of a property and communicate that information in real time to the owner, relevant authorities, and others. While these systems are especially effective at detecting intrusions and other unwanted occurrences in a home or business, it is likely that damage to the property, such as a broken door or window, has already occurred by the time the intrusion is detected.

In order to prevent invasions before they happen, security systems typically place signs on the property to indicate that a security system is installed and protecting the property. For example, many home security systems use small decals that are placed on a window of the home. These signs are ineffective at preventing invasions for many reasons. These signs or decals are small and difficult to see. Often, these signs or decals are place on windows in front of trees, shrubbery, or other decorative yard pieces, and can only be seen from short distances. Because these signs are not illuminated, these problems are compounded at night or other low light conditions. Thus, present systems actually invite intruders to approach the house in order to determine whether a property is protected by a security system. In sum, the typical methods of alerting potential intruders of the presence of a security are not effective.

For at least these reasons, security systems need new methods and systems to indicate the presence of a security system that effectively keeps potential intruders from even attempting to break into a home or business.

### BRIEF SUMMARY

In one implementation, an apparatus for indicating the presence of a security system on a property is described. The apparatus may include a doorbell button, and a lamp. The lamp may be caused to flash to indicate that the security system is present regardless of a state of the security system.

In another implementation, a method for indicating the presence of a security system on a property is described. The method may include providing a doorbell button and providing a flashing light to indicate to indicate that the security system is present regardless of a state of a security system

In another implementation, an apparatus for an apparatus for indicating the presence of a security system on a property is described. The apparatus may include a doorbell button, a lamp, a faceplate having a transparent portion, the lamp being positioned to illuminate the transparent portion of the faceplate, a processor, and a memory for storing instructions for the processor. The processor may be operable to, if a security system is present on the property, cause the lamp to flash to indicate that the security system is present regardless of a state of the security system.

These and other embodiments and aspects of the invention are described with reference to the noted FIGS. and the below detailed description of the preferred embodiments.

### BRIEF DESCRIPTION OF THE DRAWINGS

FIG. 1 is a diagram of an exemplary system for indicating the presence of a security system;

FIGS. 2A-C are exemplary flashing doorbell security lamps;

FIGS. 3A and 3B are flow charts of exemplary methods for indicating the presence of a security system on a building; and

FIG. 4 is a house employing an exemplary flashing doorbell security lamp.

### DETAILED DESCRIPTION OF THE DRAWINGS AND THE PRESENTLY PREFERRED EMBODIMENTS

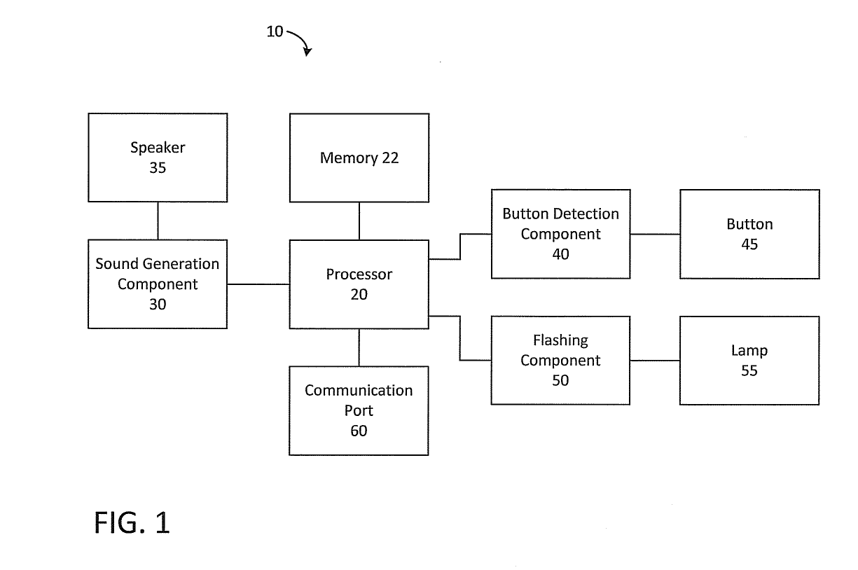

Referring to the drawings, and initially to FIG. 1, an exemplary system 10 for indicating the presence of a security system is shown. The system 10 may provide a visual indication, such as a flashing doorbell security lamp, to indicate that a property is protected by a security system. In some implementations, the system 10 may include a processor 20, a memory 22, a sound generation component 30, a button activation detection component 40, a doorbell button 45, a flashing component 50, and a lamp 55. Although reference will now be made to specific components of the system performing specific features, it should be apparent to one of ordinary skill in the art that such reference is exemplary, is not intended to limit the scope of the claims in any way, and that the functionalities described herein may be implemented in a virtually unlimited number of configurations. For example, the processor 20 may be configured to perform all of the functions of the system 10, such as the functions of the sound generation component 30, the button activation detection component 40, the flashing component 50, or any combination therein. Alternatively, or additionally, the functionality of the system 10 may be implemented by any one or more processors and/or other physical and/or logical devices that each may be used to perform a subset(s) of the various functions of the system 10.

The processor 20 may be any processor, such as, for example, a digital signal processor (DSP) or other microprocessor. The processor 20 may be in communication with the memory 22. The memory 22 may be any memory, such as a ROM, EPROM, EEPROM, or other type of flash memory. Other types of memory may also be used. The memory 22 may store instructions executed by the processor 20 to implement any and/or all of the features described herein. The processor 20 may have integrated RAM memory. Alternatively, or additionally, memory 22 may include RAM accessible by the processor 20.

The system 10 may include a power source, such as a battery or solar panel. Alternatively, or additionally, the system 10 may be connected to the mains power of the home or building, or derive power from a connected security system.

The processor 20 may be connected to a doorbell detection component 40 that is operable to detect the activation of a doorbell button 45. In response to an activation of the doorbell button 45, the system 10 may produce a sound by activating a sound generation component 30. Sound generation component 30 may produce common doorbell sounds such as those typically associated with a doorbell. Non-traditional sounds may also be produced. Sound generation component 30 may include a speaker 35 and/or any other components used to generate sounds, such as digital signal processors, amplifiers, and the like. Alternatively, or additionally, the system 10 may be operable to communicate with an external sound generating mechanism and/or external speaker. It should be apparent to one of ordinary skill in the art that the sound generation process is limited only by the manner in which sounds may be generated, and that options for such sounds and/or the components used to generate such sounds may vary from implementation to implementation without departing from the spirit and scope of the claimed invention.

The processor 20 also may be connected to a flashing component 50 that is operably connected to a lamp 55. In some implementations, the lamp 55 may be a light emitting diode (LED), a bulb, or another device that emits light. The lamp 55 may produce light of any color, such as green, blue, purple, red, and the like.

The flashing component 50 may cause the lamp 55 to flash. As used herein, the term “flash,” “flashing lamp” and/or “flashing light” refer to a light having alternating periods of operation at higher and lower levels of intensity and/or different colors. The periods may alternate at regular intervals. For example, the flashing component 50 may cause the operation of the lamp 55 to change every second, every ten seconds, every minute, and so on. Other periods of time may also be used.

Alternatively, the processor 20 may be directly connected to the lamp 55 and may further be operable to cause the lamp 55 to flash.

The lamp 55 may be caused to flash to indicate the presence of the security system. The lamp 55 may be caused to flash regardless of the state of the security system. In other words, even if the security system is not currently detecting a break-in or other hazardous or non-hazardous condition, the lamp 55 may be caused to flash to indicate that a security system is present. In this sense, the lamp 55 may be caused to flash to act as a warning to potential intruders. The lamp 55 may be caused to flash at all times that the security system is present, regardless of whether the security system is active or non-active.

Optionally, the system 10 may be connected to a security system through communication port 60. Communication port 60 may be a standardized serial port, such as an RS-485 port, RS-232 port, or Universal Serial Bus (USB) port. Other standard and non-standard communication interfaces and/or ports may be used. For example, communication port 60 may be a simple wire configuration that allows a voltage to be detected by the system 10.

In some implementations, the communication port 60 may be a wireless communications interface module that enables wireless communications with a security system, computer, or other device. For example, the communication port 60 may include a wireless local area network (WLAN) product that is based on the Institute of Electrical and Electronics Engineers' (IEEE) 802.11 standards. Alternatively, or additionally, the communication port 60 may include Bluetooth capabilities or ZigBee that enable the system 10 to communicate with other Bluetooth or ZigBee enabled devices, respectively.

The system 10 may receive information from a security system through communication port 60. The information may include status information that indicates that a security system has been installed on a property, that the security system is enabled/active or disabled/inactive, or that a given event has been detected by the security system. Possible events that may be communicated to the system 10 by the security system include any event or condition that may be detected by a security system. Such events may include, for example, the opening of a door, window or other entry point, a fire on the property, or other event or condition. Other information may also be communicated to the system 10 by a security system. It should be apparent to one of ordinary skill in the art that the information that may be communicated to the system 10 and/or the components used to communicate such information may vary from implementation to implementation without departing from the spirit and scope of the claimed invention.

The system 10, via the processor 20 and the flashing component 50, may be operable to cause the lamp 55 to flash in particular ways in response to the received status information. For example, the system 10 may cause the color, intensity, and/or flashing interval of the lamp 55 to change in response to status information. The particular flashing patterns and colors may be fixed so that the same pattern and/or color are used to indicate the same status condition in all properties. By fixing specific conditions to specific flashing patterns, the system 10 is able to provide a consistent messaging system that projects status information to others outside the property to alert them of the status of the property. Additionally, because the lamp 55 is visible from the exterior of the property, the system 10 is able to spread awareness of potential issues to others such as neighbors and passersby that may be able to provide assistance, such as, for example, calling the police or fire department.

In an exemplary implementation of the system 10, the lamp 55 may flash green every 3 seconds to indicate that the property is being protected by a security system. Upon detection of the opening of a door, the security system may communicate that information to the system 10. In response to receiving the new status information, the system 10 may cause the lamp to flash blue every second. If status information indicative of a fire is communicated to the system 10, the system 10 may cause the lamp to flash red at a high intensity level every 0.5 seconds. Similarly, other colors, intervals and/or intensity levels may be used to indicate these or other conditions of the property.

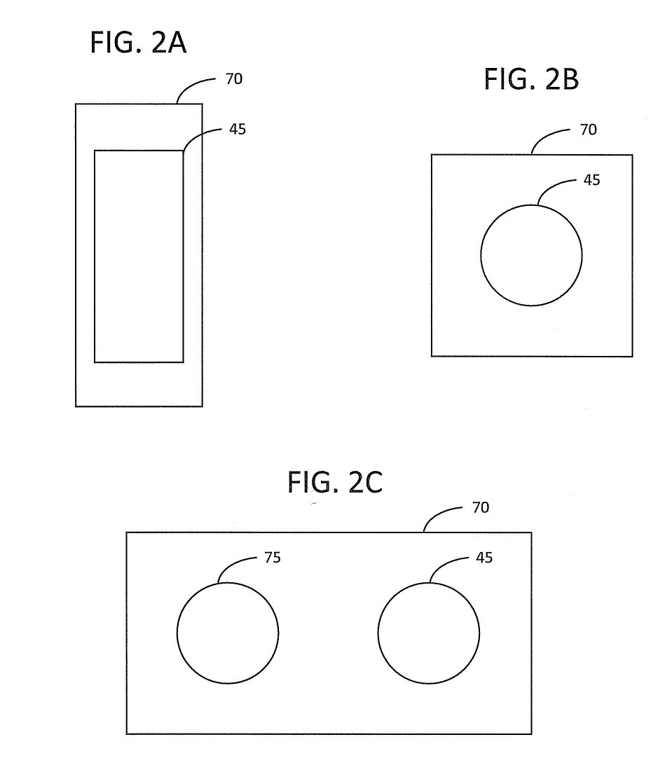

Referring now to FIGS. 2A-C, exemplary flashing lamp doorbells are shown. The exemplary flashing lamp doorbells may include button 45 and faceplates 70. For example, in FIG. 2A, an exemplary doorbell may include a rectangular-shaped button 45 backlit by the lamp 55 such that the button 45 flashes. The button 45 may be transparent and backlit by the lamp 55. Additionally, or alternatively, the entire faceplate 70 may also be backlit by the lamp 55, so that either or both the faceplate 70 and button 45 flash. FIG. 2B shows an exemplary circle-shaped button 45. The button 45 also may be backlit by the lamp 55 such that the button 45 flashes. Additionally, or alternatively, the entire faceplate 70 may be transparent so that it is backlit by the lamp 55 and flashes. Finally, in FIG. 2C, an exemplary circle shaped button 45 is shown in a faceplate 70. Additionally, a portion 75 of the faceplate 70 is transparent so that the lamp is visible through the transparent portion 75. Alternatively, or additionally, the lamp 55 may extend through an aperture in the faceplate 70.

The faceplate 70, button 45, and/or transparent portion 75 of the faceplate 70 may be any shape or size. For example, the faceplate 70, button 45, and/or transparent portion 75 of the faceplate 70 may be a square, oval, circle, rectangle, or any other shape. The faceplate 70, button 45, and/or transparent portion 75 of the faceplate 70 may each be the same shape, different shapes, or any combination thereof. Similarly, each of these components (the faceplate 70, button 45, and/or transparent portion 75 of the faceplate 70) may be any size.

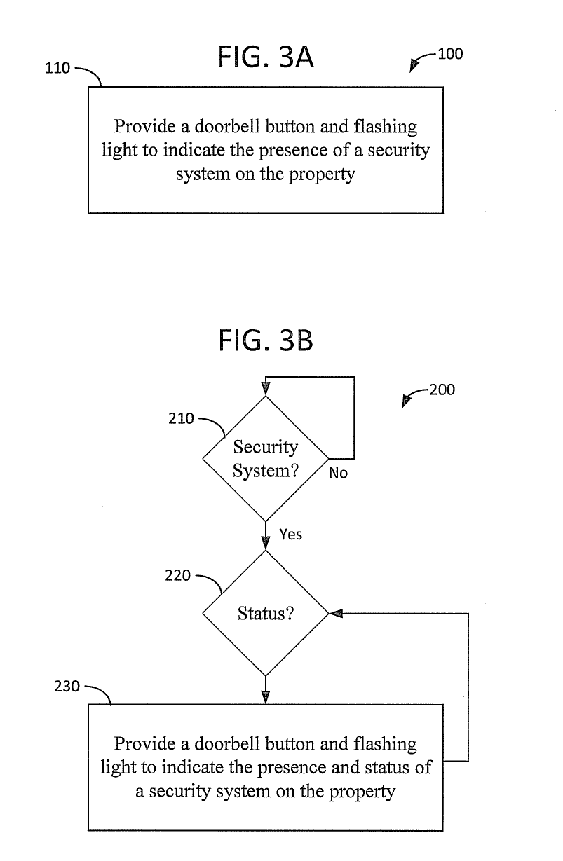

Referring now to FIGS. 3A and 3B, exemplary flowcharts for certain implementations of methods for indicating the presence of a security system on a building are shown. In FIG. 3A, the method 100 may consist of providing a doorbell button and a flashing light to indicate the presence of a security system on the property at step 110.

In FIG. 3B, the method 200 may consist of determining the presence of a security system on the property at step 210. If it is determined that a security system is present in step 210, the status condition of the property may be determined at step 220. Based on the determined status condition of the property, a flashing lamp doorbell may be provided to indicate both the presence of the security system and the current status condition of the property at step 230.

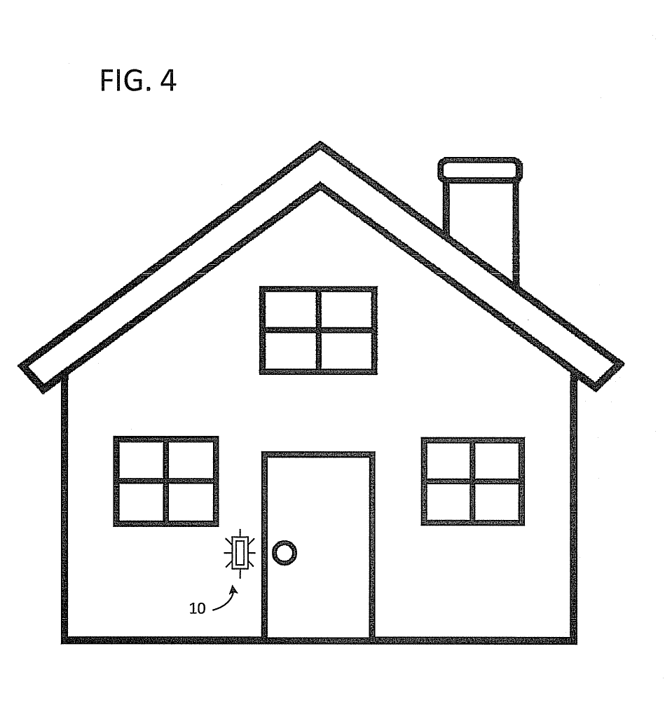

FIG. 4 shows a house employing an exemplary flashing doorbell security lamp. As seen in FIG. 4, the presence of a security system is indicated by the presence of the flashing doorbell security lamp, which may be visible from even remote locations and/or during low-light conditions. As a result, potential intruders may be deterred from approaching the house. Additionally, status information about the current condition of the house may also be communicated to those outside the house so that help can be obtained and potential disasters can be avoided.

It is therefore intended that the foregoing detailed description be regarded as illustrative rather than limiting, and that it be understood that it is the following claims, including all equivalents, that are intended to define the spirit and scope of this invention.

1. An apparatus for indicating the presence of a security system on a property, comprising:
a doorbell button; and
a lamp operable to flash to indicate that a security system is present regardless of a state of the security system.

2. The apparatus of claim 1, wherein the button is transparent and the lamp is positioned such that the lamp illuminates the button.

3. The apparatus of claim 1, further comprising a faceplate having a transparent portion, wherein the lamp is positioned such that the lamp illuminates the transparent portion of the faceplate.

4. The apparatus of claim 3, wherein the transparent portion of the faceplate is the button.

5. The apparatus of claim 1, further comprising a communication port operable to receive information.

6. The apparatus of claim 5, wherein the lamp is caused to flash in a specific manner based at least in part on the information.

7. The apparatus of claim 5, wherein the information is indicative of the current state of the security system.

8. The apparatus of claim 7, wherein the lamp is caused to flash in a specific manner indicative of the information.

9. The apparatus of claim 5, wherein the communication port is operable to communicate wirelessly.

10. The apparatus of claim 1, further comprising a processor and a memory, wherein the processor is operable to cause the lamp to flash.

11. The apparatus of claim 1, further comprising a sound generation component operable to cause a sound to be generated in response to a detection of the activation of the doorbell button.

12. A method for indicating the presence of a security system on a property, comprising:
providing a doorbell button, and
providing a flashing light to indicate to indicate that the security system is present regardless of a state of a security system.

13. The method of claim 12, wherein the doorbell button is transparent and the flashing light is positioned to illuminate the transparent doorbell button.

14. The method of claim 10, further comprising determining a current state of the security system.

15. The method of claim 14, further comprising causing the light to flash in a specific manner indicative of the determined current state of the security system.

16. An apparatus for indicating the presence of a security system on a property, comprising:
a doorbell button;
a lamp;
a faceplate having a transparent portion, the lamp being positioned to illuminate the transparent portion of the faceplate;
a processor; and
a memory for storing instructions for the processor,
wherein the processor is operable to, if a security system is present on the property, cause the lamp to flash to indicate that the security system is present regardless of a state of the security system.

17. The apparatus of claim 16, further comprising:
a communication port operable to receive status information indicative of a current state of the security system.

18. The apparatus of claim 17, wherein the processor is further operable to cause the lamp to flash in a specific manner indicative of the status information.

19. The apparatus of claim 17, wherein the communication port is operable to communicate wirelessly with the security system.

20. The apparatus of claim 16, further comprising:
a doorbell button detection component in communication with the processor, the doorbell button detection component operable to detect the activation of the doorbell button; and
a doorbell sound generation component in communication with the processor, the doorbell sound generation component operable to generate a sound,
wherein the processor is further operable to activate the doorbell sound generation component in response to the detection of the activation of the doorbell button.
